(19) United States
(12) Patent Application Publication
(10) Pub. No.: US 2003/0005090 A1
(43) Pub. Date: Jan. 2, 2003

(54) System and method for integrating network services

(76) Inventors: Robert R. Sullivan JR., Pleasanton, CA (US); Dalibor F. Vrsalovic, Sunnyvale, CA (US); Muhamed Aganagic, San Jose, CA (US)

Correspondence Address: Thomas C. Webster, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/895,999

(22) Filed: Jun. 30, 2001

(51) Int. Cl. G06F 15/177

(52) U.S. Cl. 709/220

(57) ABSTRACT

An integrated internetworking architecture for automating the configuration and control of networks that operate according to standard layered protocols. The described architecture includes two major blocks: (1) a network; and (2) a controller coupled to the network that automatically configures the network by coordinating different resources to perform an action, such as providing an e-commerce shopping service. The controller may operate at a layer above the standard network protocols so as to abstract away the visible complexity of the network, thus allowing a human user to control, configure and operate the network as if it were a single host (e.g., computer) via a simple user interface. A tool set may also be provided to simulate and evaluate the interaction of the various networked components using the properties and provisioning information maintained within the controller.

### BACKGROUND

1. Field of the Invention

This invention relates generally to the field of computer networking.

### BACKGROUND

Doing business over the Internet, whether selling goods or providing services, is very costly. First, one must invest in the basic infrastructure: a complex computer network that can include more than 100 servers, software, and network appliance elements. Each element must be configured, monitored, and managed to sustain an operational state. Second, because network downtime means lost business, one must continue to invest substantial time and resources in maintaining the network. In fact, the Cost of Ownership (COO) of complex computer networks can far exceed the initial investment. To make matters worse, the COO of complex computer networks does not scale. An incremental increase in service capacity or functionality can mean a significant increase in the complexity of the service network and, therefore, the operations costs to manage that network.

The primary contributor to the high COO of a complex network is the need for constant human supervision of the network. While network management software exists to assist the human network operator, such software offers little more than the ability to remotely control some aspects of the network or the ability to troubleshoot problems more efficiently. For example, tools like OpenView from Hewlett Packard® provide extensive network management functions (e.g., such as monitoring and control of data traffic through network routers and switches), while software tools like IBM Tivoli® provide a fairly comprehensive view of each of each of the networked computer platforms, they are not capable of performing significant “network management” functions.

Despite the existence of network management tools, the human operator remains the true network manager, and human error remains the major cause of network downtime (e.g., ˜40%). For example, the eBay service outage on Jun. 12, 1999, which resulted in a revenue hit of between $3 and $5 million, was the result of operator error. Accordingly, it would be desirable reduce the effects of human error in the management of computer networks.

The increasing complexity of computer networks also impacts the productivity of the design, provisioning, and deployment parts of the life cycle. While Computer Aided Design (CAD) has given way to Computer Aided Manufacturing (CAD/CAM) in mechanical and electronic design fields, comparable benefits in the design and deployment of complex e-Business or internet networks. In the field of mechanical CAD, an underlying volumetric model of the 3-dimensional parts being designed is the basis for motion simulation and design-rules checking, and instructions derived from the model can generally be exported to machine tools to fabricate the parts. In the field of electronic CAD, a circuit model which includes the electronic components similarly enables computer-aided simulation, design rules checking, and debugging of complex circuits. A representation of the finished circuit design can be exported and ultimated rendered as a circuit board or an integrated circuit.

A model-based approach to increasing the productivity and automating the Operations, Management, Administration, and Provisioning of complex computer networks could yield productivity benefits comparable to those realized in the fields of mechanical and electronic CAD. This invention describes such a system.

### BRIEF DESCRIPTION OF THE DRAWINGS

A better understanding of the present invention can be obtained from the following detailed description in conjunction with the following drawings, in which:

FIG. 1 illustrates a typical prior art data center configuration.

FIG. 2 illustrates a meta-server according to one embodiment of the invention.

FIG. 3a illustrates one embodiment of a meta-server architecture.

FIG. 3b illustrates one example of defined relationships between various meta-server elements using a Unified Modeling Language (“UML”) representation.

FIG. 3c illustrates a second example of defined relationships between various meta-server elements using Unified Modeling Language.

FIG. 4 illustrates a meta-server controller deployed within a network and a group of defined zones.

FIG. 5 illustrates a meta-server controller as basis for an integrated e-business solution developer's workbench based on the system model.

FIG. 6 illustrates a particular tool set according to one embodiment of the invention.

### DETAILED DESCRIPTION

In the following description, for the purposes of explanation, numerous specific details are set forth in order to provide a thorough understanding of the present invention. It will be apparent, however, to one skilled in the art that the invention may be practiced without some of these specific details. In other instances, well-known structures and devices are shown in block diagram form to avoid obscuring the underlying principles of the invention.

As described in more detail below, the inventors have developed a network integration architecture and associated Internet services platform that reduces the visible complexity of a network and enables significant automation of the network. According to the network integration architecture, network resources (both hardware and software) and the relationships between those resources are defined in a highly granular and well-understood manner, which enables network management automation, as well as a more highly integrated and scalable view of the network resources so that human operators can be more efficient and less prone to error. The network integration architecture can be implemented as an Internet services platform which is, in fact, a complex network, hidden behind a single user interface and can be controlled as if it were a single computer. Alternatively, the network integration architecture concepts can be applied to an existing network to provide similar benefits.

### A Complex Computer Network

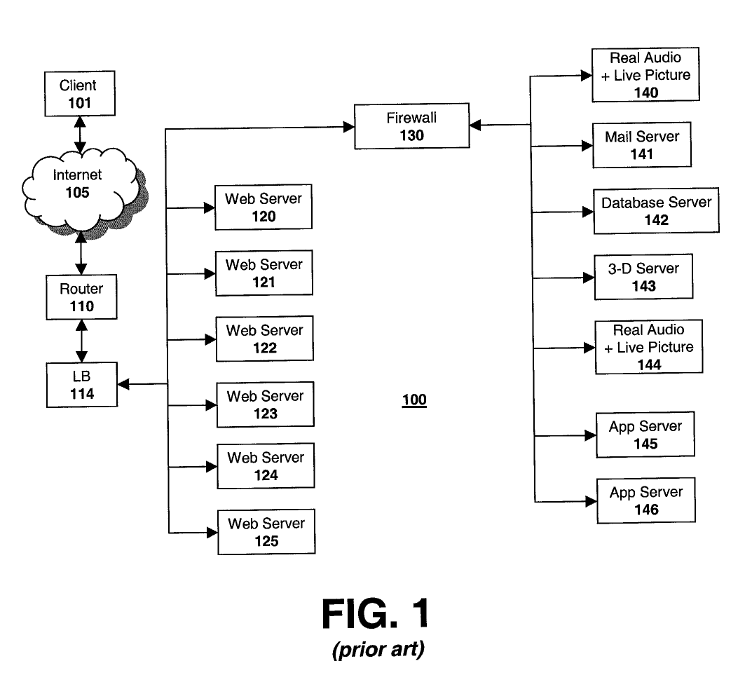

One example of a complex computer network used to do business over the Internet is the data center. A typical data center is a very heterogeneous cluster consisting of computers, networking-equipment, and various appliances. As shown in FIG. 1, a typical data center might include a router 110, a load balancer 114 a plurality of “front end” Web servers 120-125, a firewall 130 and a plurality of “back end” servers 140-146. All data transmitted and received over the Internet 105 passes through the router 110. Load balancer 114 analyzes all incoming data requests from clients 101 and forwards the requests to an appropriate front end server 120-125. The client request may be for a particular Web page stored on one of the front end servers 120-125 which includes embedded objects provided by the back end servers 140-145For security purposes, a firewall 130 monitors/controls the data traffic between the front end servers 120-125 and the back end servers 140-146.

### Meta-Server Introduction

To solve the complexity and cost problems associated with operating a complex computer network, one embodiment logically organizes all network information and services under a single, unitized “meta-server” platform. The meta-server of this embodiment is comprised of all network “components” and their existing management interfaces. By way of example but not limitation, network “components” may include network devices (e.g., load balancers, switches, routers, SSL accelerators, firewalls, . . . etc), servers including typical computers or computer clusters (e.g., from Intel, HP, IBM, Sun, . . . etc), and fixed function computers such as database appliances and compute units (e.g., such as databases, streaming media, or web-caching appliances). Various other hardware/software components may be logically incorporated within the meta-server while still complying with the underlying principles of the invention.

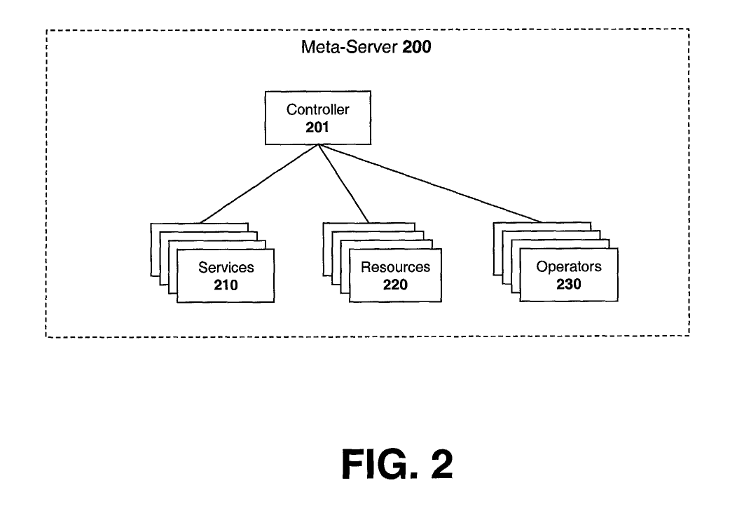

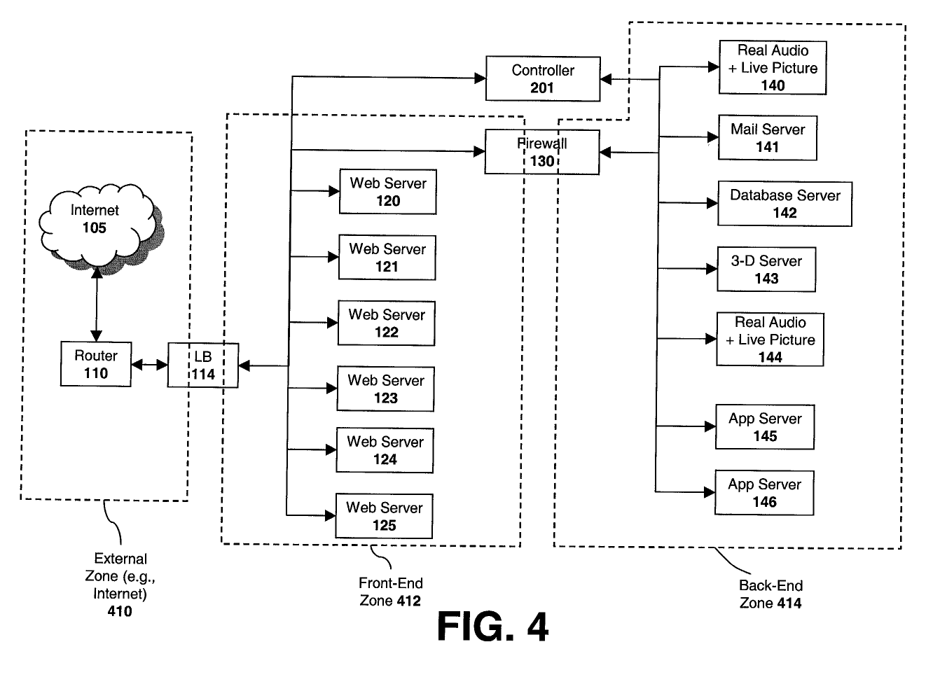

As illustrated in FIG. 2, a logical model of one embodiment of a meta-server 200 is comprised of a plurality of “services” 210 (e.g., email services, Web services, database services, . . . etc), “resources” 220 (e.g., hardware and software components) and “operators” 230. The operator portion 230 of the meta server includes a uniform security model which may be used to authorize access to the other elements of the meta-server platform (e.g., by defining groups of users with different authorization levels). Each of these meta-server elements will be described in detail below. In addition, in one embodiment, a central controller 201 (illustrated in FIG. 4) is configured to manage and collect information from each of the individual meta-server components. The meta-server controller 201 thus logically encapsulates the incorporated resources, exposing only selected summary complexity to the duly authorized operators or external systems. The meta-server controller 201 may contain a hierarchical model of the meta-server's managed elements, their individual configuration properties, associations, and interdependencies, and cached operational status of each element in the form of object properties. The meta-server controller 201's object model also may contain executable methods (automation programs) which can be invoked directly by operators or by external systems to calculate and repeat complex operations, management, administration, and provisioning sequence steps. The meta-server's controller 201 makes the underlying meta-server appear to be a single ‘logical’ element to operations personnel or external systems.

Various features of the meta-server 200 architecture may be best understood by comparing the meta-server 200 and its controller 201 to the personal computer.

For example, the operating system (“OS”) in a personal computer manages the internal hardware and software resources or components that make up a personal computer, exposing a simplified and abstracted single-system model to the user. The system model exposed by the OS to the user might be fixed, incorporating hardware elements (cpu, disk, memory, display, keyboard, other peripherals) and software elements (OS, device drivers, applications, utilities, etc).

The OS provides a user interface framework and some necessary user interface pieces that are beneficially used by all applications (e.g., dialog boxes, help with fonts and graphical abstractions, icons, buttons, slider bars, . . . etc). Similarly, the meta-server controller 201 of one embodiment provides a user interface framework that can be shared by all data center management applications (e.g., service automation applications). The user interface framework may be developed in any convenient manner while still complying with the underlying principles of the invention (e.g., using a Web server interface, an X-Windows based user interface framework, . . . etc).

In addition, in a similar manner that a computer OS provides a security model, including functions for authenticating users or other computers requesting access and/or an authorization model for associating allowed actions with each requesting user or computer, the controller 201 of one embodiment authenticates users (or systems requesting access) as members of pre-defined groups and generates views of the meta-server services 210 and resources 220 (e.g., graphically depicting operational and configuration status and offering management actions (commands) based on the selected element(s)).

The application programming interfaces (“APIs”) exposed by a personal computer operating system enable a family of compatible applications to be executed on a family of compatible personal computers. Typically, the set of APIs grow over time without unnecessarily breaking the legacy (historically established) APIs. As new operating systems are offered with new innovative functionality, exposing new APIs, the applications written for earlier versions of the operating system are still supported. In the same way, in one embodiment, the controller 201 of the meta-server 200 includes APIs and a software developer's kit that allows data center applications to discover, access, and manipulate components managed under the meta-server platform. Accordingly, as the controller 201 API is extended to expose new functionality, the compatibility of older system management and automation applications is preserved.

The API exposed by the controller 201 may be used by Management Service Providers (who develop management services application frameworks) and/or automation software vendors (“ISVs”) (who write the individual site lifecycle automation and management applications). As described above, the controller 201 may include a user interface capability for use by individual persons responsible for operation, maintenance, administration and configuration of the meta-server 200. In addition, in one embodiment, other computers (or other meta-server controllers which, for example, may manage a hierarchy of meta-servers) and system management tools may access a meta-server 200 as they do the individual internet service components today.

The OS for a typical computer reduces the programming and user interfaces to devices (such as display, printers, block devices, etc.) to an abstracted and extensible common-denominator interface known as the device-driver interface. Similarly the OS typically reduces interfaces to common system services to ad-hoc standard interfaces such as SQL server API (for database), and MAPI or VIM API (for messaging).

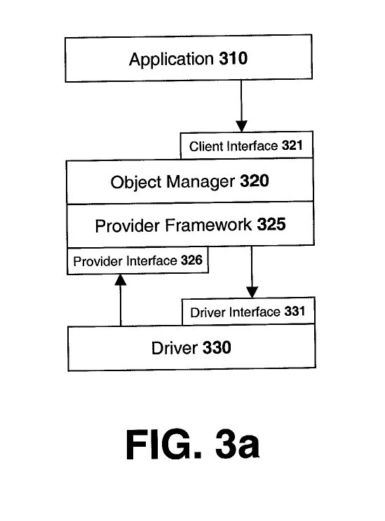

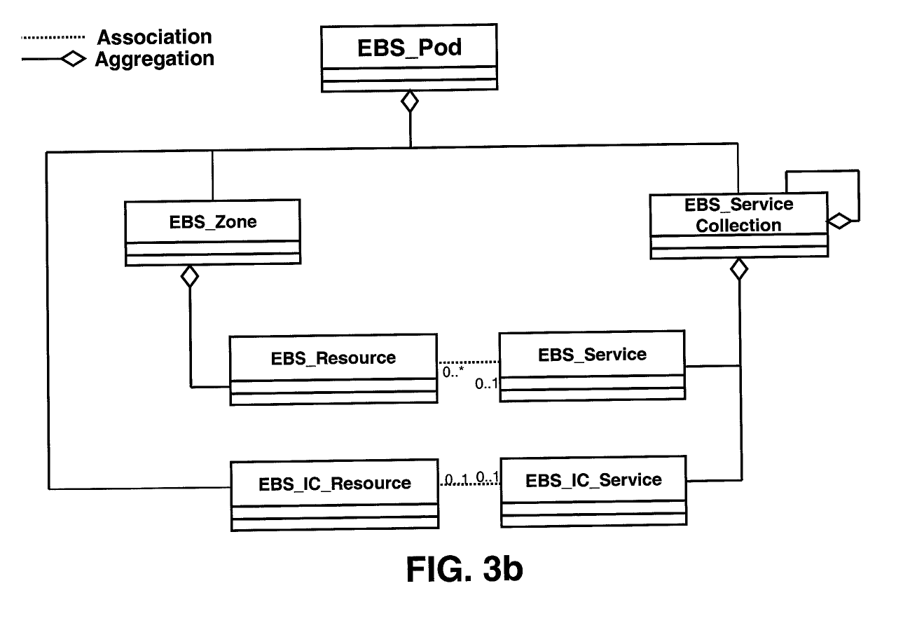

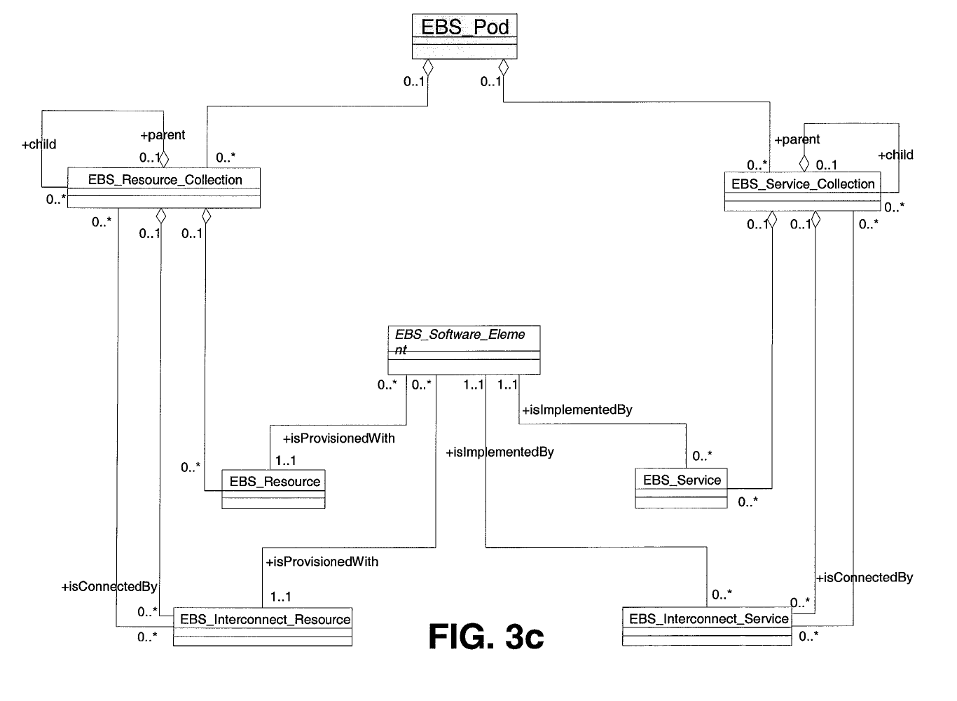

This practice has an important result for makers of computer applications: it allows apps to be written to stable and device- or subsystem-independent interfaces, thus enabling interoperability and use on a large set of otherwise incompatible computers. The stabilized Controller 201 interfaces (Client Interface 321, Object Manager 320's internal model which includes but is not limited to the schema described in FIG. 3b, Provider Interface 326, and Driver Interface 331) have a similar impact and benefit for those who create Operations, Management, Administration, and Provisioning automation applications.

Just as stable interfaces and internal model of the computer OS greatly improve the economic Return on Investment (ROI) for computer desktop productivity applications, the stable abstracted interfaces and internal model which constrains the represented inter-element object associations within the Meta-Server 200 Controller 201 greatly improve the economics for OAM&P and automation applications. An automation application or rule engine can be written to apply more generally to all compliant embodiments of the Meta-Server 200 because of the common interfaces and model. Because of the stable interfaces and internal model of the Meta-Server 200 Controller 201, a common and uniform User Interface to the Meta-Server and its Services 210 is available to operations personnel no matter what those Services may be.

### Embodiments of a Meta-Server Network Management Architecture

One embodiment of a meta-server architecture used to facilitate the network management and control functions described herein is illustrated in FIG. 3a. The illustrated architecture may comprise software executed on a server. However, it should be noted that various architectural components described herein may be implemented by hardware, software or any combination thereof. As illustrated, the meta-server architecture is comprised generally of three components: Applications 310, an Object Manager 320 and Drivers 330.

Object Manager

The object manager 320 of one embodiment embodies an object model (described below) to support the meta-server network management architecture. It also provides the mechanisms to instantiate the object model and perform operations on specific instances of an object. Three interfaces (i.e., APIs) are provided to facilitate this level of operation: a client interface 321, a provider interface 326, and a driver interface 331.

A provider framework 325 allows new/different types of “providers” to be added to the object manager 320, each of which may include additional object classes and/or operations to enhance the functionality of the object manager 320.

The Object Manager 320 generally includes a representation of classes of objects as described in the typical internal model, or schema, as described by example in FIGS. 3b and 3c.

Client Interface

The constrained association relationships, default properties, and default methods for each class of objects represented within the Object Manager 320 are a part of the defined Client Interface 321 which is then used by various Applications 310. In other words, in one embodiment, the client interface exposes a set of operations that can be performed on the instances of objects from the model (i.e., provided by the object manager 320). The client interface 321 provides an application programming interface (“API”) which may be used by applications 310 to configure, query, or manipulate the instances of the objects provided by the object manager 320. A graphical user interface is one such application which provides a graphical, external representation the object model and allows the objects to be displayed and graphically manipulated. A rule engine is another application which can use pre-defined rules to respond to events, changes of status, or invocation of methods associated with the objects within the Object Manager 320.

Provider Framework

The Provider Framework 325 and Provider Interface 326 are a possible embodiment of the interconnection and connection between the Object Manager 320 and the Driver(s) 330.

Changes to the properties represented in an object managed by the Object Manager 320 which are initiated through the Client Interface 321 are propagated to the Drivers 330 and ultimately to the managed Services 210 and Resources 220 in a reliable and efficient manner by the Provider Framework 325.

When an Application 310 invokes an object's method through the Client Interface 321, the action is reliably and efficiently invoked in the Driver 330 by the Provider Framework 325. As described below, the Driver ultimately effects the requested action on the managed Service 210 or Resource 220.

When the state of a managed Service 210 or Resource 220 changes, the interaction between the Driver 330, the Provider and Provider Framework 325 (through the Provider Interface 326) causes the associated property in the object managed by the Object Manager 320 to be reliably and efficiently updated.

Provider Interface

Within a typical embodiment of the Meta-Server Controller 201, the connection between the Provider Framework 325 and the Drivers 330 which act on or query the managed Services 210 or Resources 220 could be realized in a variety of means. The Meta-Server Controller 201 and its parts described herein could be embodied along with Drivers 330 and some or all of the managed Services 310 and/or Resources 320 on a single virtual, logical, and/or physical system. Alternatively the parts described here could be embodied on virtual, logical, or physically distinct system. Whether Providers and Provider Framework 325 are on the same system as the Drivers 330, or not, a variety of physical connections or links, network and transport protocols, and/or object interfaces or remote procedure call (“RPC”) mechanisms may be utilized.

The common (defined for a particular embodiment or for a compatible set of embodiments) architecture of the Provider Framework 325 and Driver(s) 330 enable Provider Interface(s) 326 to be adapted to commonly used (and thus convenient) interconnection means including (but not limited to) internal system APIs and binary compatibility interfaces (“ABI”s), well known protocols such as SNMP, WBEM, Telnet, HTTP, HTTPS, or CORBA, or through specific and custom means suited to and incorporated within a particular embodiment.

A managed object provider is a provider through which operations on the various meta-server levels of abstraction described below (e.g., resource, interconnect resource, service, interconnect service, . . . etc) may be manifested in the real world. The drivers 330, which communicate with the managed object provider through the provider interface 326, provide the physical manifestations of each of the meta-server operational requests.

Driver Interface

The driver interface 331 is a set of operations through which the object manager 320 performs a management operation on a device (e.g., start, stop, status requests, . . . etc). The management operations request is transmitted through the provider framework 325.

### Defined Relationships Between Meta-Server Components

In one embodiment, the meta-server object model is defined using Unified Modeling Language (“UML”) terminology. This embodiment provides a well understood object design nomenclature of Classes, Operations, Attributes or Properties, and Associations. For example, two such embodiments of a meta-server as represented in its controller 201 are described by the UML object diagrams illustrated in FIGS. 3b and 3c, which show the Class names, Aggregations, and Associations between various defined meta-server objects. (The names for FIG. 3b are described below).

A meta-server controller 201 is illustrated in FIG. 4 configured within a data center. The load-balancer 114 of this meta-server embodiment forwards incoming management connections directly to the controller 201, which acts as a “proxy” and/or control gateway for all network management interactions. The controller may perform network/platform monitoring and network control functions based on various levels of abstraction defined using the object model. For example, in one particular embodiment, the following levels of abstraction are defined:

Pod: A “Pod” represents the entire system and is the highest aggregation point of the object model. It is an aggregation of Zones, Interconnect Resources, and Services Collections (all of which are described below). In the example topology, the Pod would describe all the components in FIG. 4, excluding the controller 201.

Zone: A “Zone” is a named logical grouping of execution or storage resources (e.g., servers) that provide a contained execution for Services or their components. In one embodiment, only certain types of resources may be placed in Zones. For example, network or other communication between Zones is provided/mediated by Interconnect Resources. Three zones are defined in the embodiment described in FIG. 4: an Internet (or external) zone 410; a front-end zone 412; and a back-end zone 414. Of course, various other zone definitions may be provided while still complying with the underlying principles of the invention. Only the front-end zone 412 and the back-end zone 414 contain resources. The Internet zone 410 does not contain any resources, but its definition may be used to define the interconnect resources (described below).

Interconnect Resource: An interconnect resource is a resource that participates in two separate Zones. More specifically, in one embodiment, an Interconnect Resource is a named logical grouping of communication resources that provide gateway (for example bridging or routing) services between zones or environments external to the Pod. Only certain types of managed objects may be represented as Interconnect Resources. In the example topology described in FIG. 1, the Internet Router 110, the Load Balancer 114, and the Firewall 130 would be configured as Interconnect Resources. In one particular embodiment, there are two types of Interconnects: Intra-Pod Interconnects that connect two zones within the pod, and Extra-Pod Interconnects that connect zones with the external environment. An Intra-Pod Interconnect may be under the full management of the controller, whereas an Extra-Pod interconnect may not (i.e., due to the inability of the controller to manipulate external variables such as IP address assignment, because the communications path to the Extra-Pod Interconnect Resources is constrained or denied for security reasons, etc.).

Interconnect Resources are an important abstraction of the Integrated Network Services invention. In one possible embodiment, a method in an Interconnect Resource's object, managed by the Object Manager 320 in the Controller 201, could enumerate the intra-Zone communications requirements for each of the adjacent Zones.

In an example IP protocol-based system, these requirements could be aggregated as “source” and “sink” IP addresses, port-numbers (transport layer requirements) as well as round-robin, least recently used, or other (application protocol layer) requirements. Once the requirements are enumerated and aggregated for the adjacent Zones, the method to (re-) provision the Interconnect Resource could be translated from a common and convenient internal Controller 201 representation into specific Route and Policy provisioning instructions (for example) to the specific Interconnect Resource. Similar mechanisms can be fully implemented for other, non-IP protocols or interconnect mechanisms.

Thus, a dynamic Provisioning and Re-Provisioning method could be implemented for the Interconnect Resource class, allowing complex network provisioning tasks to be fully automated. As Services 210 or Resources 220 are added, removed, enabled, disabled, brought online or as they fail, the associated Interconnect Resources can be reconfigured automatically.

Resource: Resources include devices, networks, systems, and applications. A Resource is typically contained entirely in a single Zone. This relationship is expressed by an association between the Resource and the Zone in the model managed by the Object Manager 320. The Resource can have any number of Services running on it. In the example topology illustrated in FIG. 4, all of the servers 120-125, 140-146 may be instances of the Resource object. A number of standards exist or are emerging, such as Web Based Enterprise Management (“WBEM”), for communicating with managed resources. While the Controller 201 of one embodiment will provide support for WBEM (among others), the controller architecture is protocol-neutral.

Service: A Service may be a comprehensive and self-sufficient process or set of processes. A service runs on a single Resource. In the sample topology, the services running on the server resources are instances of the Service object (e.g., Web Services, database services, audio/video services, . . . etc).

Service Collection: A Service Collection represents an aggregation of Services and/or other Service Collections. In the example topology, the Web Services provided by servers 120-125 may be aggregated into a single “Web Service” Collection. Then the Web Services can be operated on collectively by operating on the defined Service Collection. The Service Collection can also be used to define a Load Balance Service (provided by load balancer 114), a Firewall Service (provided by firewall 130) and a Live Picture Service (provided by servers 140 and 144). In one embodiment, the entire site is a special Service Collection is that it cannot be aggregated into another Service Collection, but may be aggregated into a pod.

### Meta-Server Applications

Several application-specific embodiments of the meta-server will now be described. It should be noted, however, that these examples are for the purpose of illustration only and should not be read to limit the underlying principles of the invention.

Control and Management Gateway

Independent service providers (so called “xSPs”) and in-house information technology groups are frequently called upon to establish service level agreements, or “SLA's.” In current data centers, the customers-to whom the SLA's are promised-require ongoing access to the managed components. Frequently the end-customer is provided with the “root password” to his/her servers, and is able to start and stop, to reconfigure, or even to re-provision or upgrade operating system or application software without necessarily notifying the service provider.

As a result, any attempts to audit or log the access and changes, or to enforce agreed-upon rules in the SLA (e.g., remote console sessions are allowed only after backup is completed, enabling recovery from unforeseen consequences of the control actions taken during the remote console session, . . . etc) are bypassed.

Since all control and management actions are routed through the meta-server controller 201, after the operator or agent has been properly authenticated and duly authorized, strict access control is enforced. The most commonly used actions are exposed as Methods (or “buttons” in the graphical user interface of the Controller 201) and thus can be invoked, executed, and logged in the Controller 201's event log without ambiguity or operator errors. Remote console or other access to individual components (when allowed for a specified Group of properly authenticated Users) occurs through a “proxy” service spawned within the controller 201 as required. This “proxy” function can constrain and log keystrokes and actions taken as necessary.

In one embodiment, the system model in the meta-server controller 201 contains the current operational status of the meta-server 200, and this information is exposed to authorized agents through the controller's supported management interfaces (e.g., the Client Interface 321, exposed over a remote invocation mechanism and protocols which can include SNMP, HTTP or HTTPs, XML, WBEM, or any other machine-to-machine interfaces, as required) so that higher level management systems in use in the data center may be integrated. Generally each individual meta-server 201 would be represented in a higher level management system as a single logical element, but the individual meta-servers 201 could alternately be federated together into a single logical and virtual Datacenter as exposed by a meta-meta-server. In this latter case, a meta-server controller 201 would incorporate individual meta-servers into a 2^{nd} level meta-meta-server. This hierarchy could be thus extended to multiple levels as appropriate to scale up the Integrated System Management system concept for large scale deployments.

The controller 201 then extends and complements the capability of existing systems management tools where already in use by providing a “top-down” or hierarchical status of the meta-server on all supported consoles. In one embodiment operators may open a secure session with the desired meta-server and monitor/control a given customer or service simply by selecting a meta-server icon provided on his/her console.

Customer Management Portal

A meta-server user interface is provided in one embodiment which is extensible and based on the self-contained web server, which has access (through the Client Interface API) to the system model, objects for managed elements and their status/properties, and methods in the running meta-server 201 system. The common internal model of the Object Manager 320 and the uniform Client Interface 321 enable a “dynamic GUI” web interface to be implemented. With one set of HTML pages and associated web server back-end scriptlets (or similar) the meta-server embodiment managed by the controller can be uniformly exposed to the web client and the properly authenticated User. One set of HTML “dynamic GUI” web interface pages is thus able to represent any possible instantiation of objects into the controller 200's meta-server system. This means that “custom” UI pages are synthesized or dynamically created for certain groups of authenticated users, exposing only the objects, properties, and/or methods they're authorized to interact with.

Custom pages in the user interface may be created, then, which correspond and correlate to the contractual SLAs obligations in force between a service provider and the owner (service provider's customer) of the services running on a deployed meta-server 200. Performance to the service provider's obligations can be summarized, reported, and graphically displayed by the custom pages in the user interface. System performance and uptime, transaction response times, asset and software license management, and even links to associated customer service applications like trouble ticket disposition and billing may be provided within the user interface.

Services which are obligated and/or offered under the SLA, or even optional value-added services, can be initiated automatically from within the meta-server controller user interface. Moreover, methods, which are associated with services running within the meta-server 200, can be implemented as simple scripts. Alternatively, or in addition, they can instead invoke method programs added through the client interface API 321.

The user interface can be used generally (e.g., according to the configured permissions for the logged-in user's group) to interact with automation applications that have been loaded and executed on the meta-server controller 201. One example of such an application is a rule-engine that hooks meta-server events (system events of all kinds) and filters or qualifies them against user-defined rules, in order to initiate auto-restart or auto-failover fault recovery, trouble call-out, or SLA non-compliance notification. For example, if a particular server crashes on the network, this event may trigger a fault-recovery application on the controller 201 which will then bring the server and/or any other system components back online in the right order.

Automation Application Platform

The operational costs associated with managing complex networks/systems outweigh capital, and sometimes even bandwidth costs for a typical Internet service deployment. Within the scope of a given meta-server 200 (or even across a federation of coherently configured meta-server's) a programmer using the client interface API 321 can specify a partially or fully qualified reference to any object within the meta-server 200 (i.e., provided via the object manager 320). The permissions may be based on the agent's name and authentication credentials may be enforced at the API 321 boundary, with fine-grained control by the system configurator (e.g., at the level of individual properties and methods of individual objects).

The internal model of the controller 201 may be modified or extended. In one embodiment, this can be done on-the-fly, through the API; in another embodiment, extension of the internal model is accomplished by re-configuring and re-starting the controller. This allows extension of the system model to include phantom services and providers that include new scripts and runtime programs as needed to implement desired functionality.

Encapsulation of Components into “Unitized” Deployment Building Block

The meta-server controller 201 may be configured as a stand-alone component to existing E-Business or Internet service systems. By re-using and, where necessary, writing the relatively simple “Providers” for the necessary system components, the configuration and runtime-support for any system which implements IP-based services can be achieved.

Numerous deployed and to-be-deployed internet services, Web sites, and related E-Business systems share strikingly similar topologies, and use common or largely compatible individual components. The meta-server notions comprehend an opportunity for platform vendors, value-added resellers, or integrators to form unitized meta-server platforms (e.g., using off-the-shelf components). Certain topologies are common enough to be predictable as starting points for such off-the-shelf, unitized meta-server configurations: simple two-tier systems, with a reasonable ratio of web-heads & proxies in the front-end, behind a load balancer, and with a few (e.g., 3, 4) applications/database servers in the back-end and a firewall between the subnets.

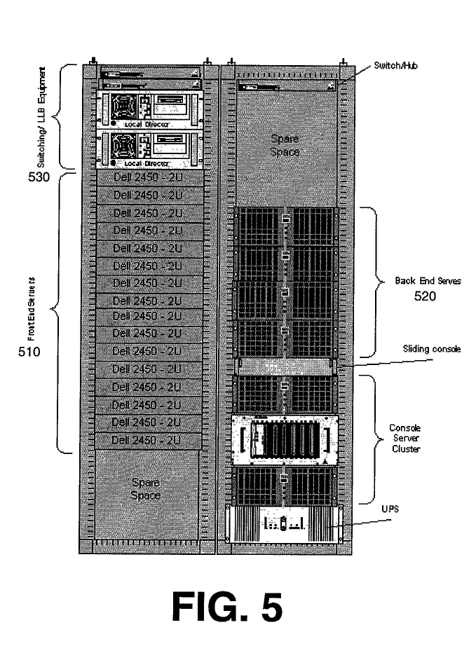

One embodiment of such a system is illustrated in FIG. 5, which includes front end servers 510, back end servers 520 and all other necessary networking logic (e.g., routing, switching, load balancing, . . . etc) within a single unitized platform. The meta-server components may be packaged with common sheet metal, redundant power & interconnects, and with serviceability features, thereby significantly reducing overall system costs. In one embodiment, a meta-server may also include hot-swappable, high-integration, board level components. Moreover, in one embodiment, the meta-server is supported by a dynamically configurable “backplane” interconnect technology (e.g., based on Fiberchannel™ or InfiniBand™ technology).

Since the meta-server architecture described herein manages and encapsulates the components of deployable “unit” capable of fully implementing an internet service or services, the deployment and operation of such services is greatly simplified. Unitized deployment, and the associated “hiding” of the internal busses and complexity offers significant benefits over current data center solutions.

Since the meta-server controller 201 includes the configuration, provisioning methods, and status of the running data center services, an automation application extension is provided in one embodiment to bring “Plug and Play” functionality at the component level to the meta-server. An meta-server “add-on” module that extends the existing subnets and zones, or which augments the existing topology of the running meta-server(s), could literally be dropped next to an operating meta-server. Upon successful interconnect and power-up, the meta-server controller 201 of this embodiment automatically recognizes the new module(s), and automatically allocate, provision, configure, and install the resources to the running site. These concepts are generally enabled by the meta-server functionality described herein.

The meta-server 200's controller 201 embodiment may contain (within the Object Manager 320) the complete set of information needed to provision, configure, test, and run the services within the meta-server 200. This information may include (but is not limited to) the source network path or filename for each Resource 220's OS, additional agents, installable software packages, and runtime content. The meta-server 200 can thus “import” a complete description of the software, configuration, and content necessary to instantiate a Service Collection on a particular meta-server 200 “Pod”, including the automation and management framework. Thus the “imported” description (and the software modules included by file or network pathname reference) are loosely comparable to a “silent install” script or program used to rebuild a single personal computer or server—except that the imported description loads an entire meta-server and its controller.

Similar productivity gains have been realized in other engineering and manufacturing/operations fields when an underlying system model has enabled a cohesive relationship between tools used in the design, validation, and manufacturing life-cycle. For two examples, consider mechanical computer-aided-design (CAD) and electronic CAD.

In mechanical CAD, an engineer uses a design tool to capture the form and function of a conceptual idea into a mechanical CAD program (like AutoCAD). Internal to the CAD program, a three-dimensional volumetric model of the system is created and manipulated by the designer. Ultimately the mechanical system described in this model can be tested for design rules (tolerances and dimensional fit between elements, for example), and a simulation of the interaction of the elements can be run on the design tool. Ultimately the components of the modeled system can be manufactured by machine tools using “tool-paths” and other instructions derived from the tool system's volumetric model. Standardization of the mechanical models and machine tool instructions has economic benefits for the makers of individual tools, simulation systems and machine tool controllers, and is important for realization of the CAD/CAM (computer-aided-design and computer-aided-manufacturing) systems presently available.

Similarly, electronic CAD uses a model of a circuit being designed to gain similar benefits. Conceptual design starts by dragging and dropping components (transistors, capacitors, etc) on the screen. Design rules can be run (to perform basic validity checking: no shorts or unconnected elements, etc). Models (ref: Spice or similar) of the individual components can be combined, and test signals can be simulated, to perform dynamic simulations of the described system. Ultimately, representations of the validated circuit can be exported based on the circuit model to manufacture the circuit as an application-specific integrated circuit (ASIC) or circuit board. Standardized representations of the circuit model (for example, ref VHDL) enable economic benefits and interoperability between tool chain components, thus increasing overall CAD/CAM productivity.

The internal model of a meta-server and the services running thereon can be compared to the volumetric models or circuit models that enable life-cycle productivity described in the examples above. The meta-server's Services and their interaction can be checked and simulated by the tools based on the properties, provisioning information carried within the meta-server model. The Operations, Administration, Management and Provisioning automation methods and the rule-sets that invoke them can be fully manipulated and verified in the simulation environment. Thus, computer-aided-design and computer-aided-operations (CAD/CAO) benefits can be realized from the model described in this invention and its embodiments.

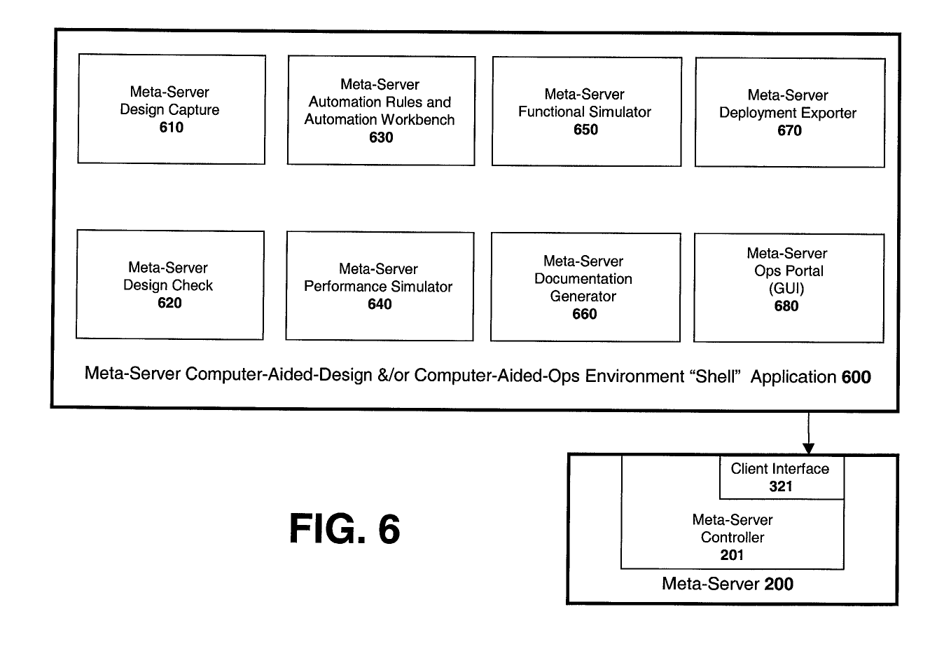

Specifically a tool chain, comparable to the tool chain described for the mechanical and electronic CAD fields described above, can be created for use with the meta-server and its internal architecture. One such tool chain, employed in one embodiment, is described in FIG. 6, which includes a meta-server controller 201, the Client Interface 321, and tools which are special purpose Applications 310 as described with respect to FIG. 3a.

Different embodiments of the system may employ different sets of tools. The examplary tools referenced in FIG. 6 include (but are not limited to) Meta-Server Design Capture 610, Meta-Server Design Check 620, Meta-Server Automation Rules and Automation Workbench 630, Meta-Server Performance Simulator 640, Meta-Server Functional Simulator 650, Meta-Server Documentation Generator 660, Meta-Server Deployment Exporter 670, Meta-Server Ops Portal 680 (which, for example, might include the “dynamic GUI” user interface or other Custom pages as required), and the Meta-Server Maintenance Assistant (not shown).

Embodiments of the invention may include various steps, which have been described above. The steps may be embodied in machine-executable instructions which may be used to cause a general-purpose or special-purpose processor to perform the steps. Alternatively, these steps may be performed by specific hardware components that contain hardwired logic for performing the steps, or by any combination of programmed computer components and custom hardware components.

Elements of the present invention may also be provided as a computer program product which may include a machine-readable medium having stored thereon instructions which may be used to program a computer (or other electronic device) to perform a process. The machine-readable medium may include, but is not limited to, floppy diskettes, optical disks, CD-ROMs, and magneto-optical disks, ROMs, RAMs, EPROMs, EEPROMs, magnet or optical cards, propagation media or other type of media/machine-readable medium suitable for storing electronic instructions. For example, the present invention may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection).

Throughout this detailed description, for the purposes of explanation, numerous specific details were set forth in order to provide a thorough understanding of the present invention. It will be apparent, however, to one skilled in the art that the invention may be practiced without some of these specific details. In certain instances, well known structures and functions were not described in elaborate detail in order to avoid obscuring the subject matter of the present invention. Accordingly, the scope and spirit of the invention should be judged in terms of the claims which follow.

What is claimed is:

1. A system comprising:
a network including a plurality of components; and
a controller coupled to the network and operative to automatically configure the components of the network to perform a combined action.

2. The system of claim 1 wherein the controller defines relationships between the components to configure them to perform a combined action.

3. The system of claim 1 wherein each resource is one of hardware and software.

4. The system of claim 1 wherein the action includes providing a network service.

5. The system of claim 1 wherein the controller automatically configures the network in response to detecting an event.

6. The system of claim 5 wherein the event is generated in response to automatically detecting increased network usage.

7. The system of claim 6 wherein the network includes a plurality of resources, the controller assigning additional resources to provide a network service that is already being provided by other resources in response to the event.

8. The system of claim 5 wherein the event is generated in response to the controller detecting demand for a new network service.

9. The system of claim 8 wherein the demand for the new network is issued in response to a command issued by a user of the system.

10. The system of claim 1, further comprising:
a console coupled to the controller operative to provide an interface that allows a human user to interact with the controller.

11. A method comprising:
logically grouping a plurality of components at a data center into a single meta-server;
defining one or more hierarchical relationships between each of said components including one or more associations, dependencies and/or prerequisites, said hierarchical relationships providing information related to network operations at said data center; and
using said information for one or more network management functions at said data center.

12. The method as in claim 11 wherein a first one of said defined hierarchical relationships comprise:
a first zone or resource collection comprised of a first subset of said plurality of components.

13. The method as in claim 12 wherein a second zone or resource collection of said defined hierarchical relationships comprise:
a second zone comprised of a second subset of said plurality of components.

14. The method as in claim 13 wherein a third one of said defined hierarchical relationships comprise:
an interconnect logically connecting said first zone and said second zone.

15. The method as in claim 12 wherein one of said components grouped within said first zone is a Web server.

16. The method as in claim 13 wherein one of said components grouped in both said first zone and said second zone is a firewall.

17. The method as in claim 11 wherein one of said components is a router.

18. The method as in claim 11 wherein one of said network management functions is to initialize one or more of said system components at said data center and said defined hierarchical relationships between each of said system components is used to determine an appropriate order in which to initialize said one or more components.

19. The method as in claim 18 wherein initializing comprises rebooting one or more of said system components.

20. The method as in claim 18 wherein initializing comprises restarting one or more of said system components.

21. The method as in claim 18 wherein initializing comprises reconfiguring one or more of said system components.

22. A meta-server comprising:
a plurality of front end Web servers to process client requests for Web pages;
a plurality of back-end servers to perform various back-end processing functions associated with said client requests;
a controller to define one or more logical hierarchical relationships between each of said components including one or more associations, dependencies and/or prerequisites, said hierarchical relationships providing information related to network operations at said data center and to use said information for one or more network management functions at said data center.

23. The meta-server as in claim 22 further comprising:
a firewall communicatively coupled between said front-end Web servers and said back-end servers to analyze and filter data traffic directed towards said back end servers,
said controller further defining one or more additional logical hierarchical relationships between said firewall and said front-end and/or said back-end servers.

24. The meta-server as in claim 23 further comprising:
a router communicatively coupled between said front-end Web servers, said back-end servers and an external network, said router to process data traffic according to a network addressing protocol,
said controller further defining one or more additional logical hierarchical relationships between said router, said front-end servers, said back-end servers and/or said firewall.

25. The meta-server as in claim 22 wherein said front-end servers and said back-end servers are physically configured within a single unitized platform.

26. The meta-server as in claim 25 wherein said front-end servers and said back-end servers communicate over a dynamically configurable backplane bus.

27. The meta-server as in claim 22 wherein said defined hierarchical relationships comprise a first zone including said front-end Web servers, a second zone including said back-end servers, and an interconnect logically coupling said first zone with said second zone.

28. The meta-server as in claim 24 wherein said defined hierarchical relationships comprise a first zone including said front-end Web servers, a second zone including said back-end servers, an interconnect logically coupling said first zone with said second zone, and an interconnect resource comprised of said firewall.

29. An article of manufacture including program code which, when executed by a machine, cause said machine to perform the operations of:
logically grouping a plurality of components at a data center into a single meta-server;
defining one or more hierarchical relationships between each of said components, said hierarchical relationships providing information related to network operations at said data center; and
using said information for one or more network management functions at said data center.

30. The article of manufacture as in claim 29 wherein a first one of said defined hierarchical relationships comprise:
a first zone comprised of a first subset of said plurality of components.

31. The article of manufacture as in claim 30 wherein a second one of said defined hierarchical relationships comprise:
a second zone comprised of a second subset of said plurality of components.

32. The article of manufacture as in claim 31 wherein a third one of said defined hierarchical relationships comprise:
an interconnect logically connecting said first zone and said second zone.

33. The article of manufacture as in claim 30 wherein one of said components grouped within said first zone is a Web server.

34. The article of manufacture as in claim 31 wherein one of said components grouped in both said first zone and said second zone is a firewall.

35. The article of manufacture as in claim 29 wherein one of said components is a router.

36. The article of manufacture as in claim 29 wherein one of said network management functions is to initialize one or more of said system components at said data center and said defined hierarchical relationships between each of said system components is used to determine an appropriate order in which to initialize said one or more components.

37. The article of manufacture as in claim 36 wherein initializing Comprises rebooting one or more of said system components.

38. The article of manufacture as in claim 36 wherein initializing comprises restarting one or more of said system components.

39. The article of manufacture as in claim 36 wherein initializing comprises reconfiguring one or more of said system components.

40. A method comprising:
defining one or more logical hierarchical relationships between a plurality components on a network including one or more associations, dependencies and/or prerequisites, said logical hierarchical relationships providing information related to network operations; and
executing a simulation of said network operations based on said hierarchical relationships between said components.

41. The method as in claim 40 further comprising:
storing different groups of said logical hierarchical relationships into one or more tool sets, said tool sets usable for conducting said simulation.

42. The method as in claim 41 further comprising:
using results of said simulation to design additional logical hierarchical relationships between said components.

43. The method as in claim 42 wherein designing additional logical hierarchical relationships comprises optimizing said logical hierarchical relationships between said components.

44. The method as in claim 42 wherein said additional logical hierarchical relationships are designed responsive to an inclusion of new components on said network.

45. A network management architecture defined by a series of abstractions comprising:
a plurality of network resources;
one or more services, each comprised of a specified set of said network resources;
a service collection comprised of two ore more services; and
a user interface providing information related to and control over said service collection, said services, and/or said network resources to a user.

46. The network management architecture as in claim 45 wherein one of said resources is a Web server.

47. The network management architecture as in claim 46 wherein one of said resources is a load balancer.

48. The network management architecture as in claim 47 wherein said Web server and said load balancer both are included in a particular service.

49. The network management architecture as in claim 46 wherein said Web server is included in a particular service with a plurality of other Web servers.

50. The network management architecture as in claim 45 wherein said user is provided with differing levels of access to said service collection, said services, and/or said network resources, depending on a user group to which said user belongs.

51. The network management architecture as in claim 50 wherein said user is provided with access to specified objects, properties and/or methods of one or more of said services, service groups and/or resources based on access privileges of said user group.

52. The network management architecture as in claim 51 wherein said user interface dynamically displays to said user only those specified objects, properties and/or methods to which said user is permitted access.
